(19) United States
(12) Patent Application Publication
(10) Pub. No.: US 2026/0303877 A1
(43) Pub. Date: Oct. 1, 2026

(54) CODING METHOD, APPARATUS AND DEVICE

(71) Applicant: Beijing Zitiao Network Technology Co., Ltd., Beijing (CN)

(72) Inventors: Chenguang SONG, Beijing (CN); Hao CHEN, Beijing (CN)

(21) Appl. No.: 19/633,917

(22) Filed: Mar. 30, 2026

(30) Foreign Application Priority Data
Mar. 31, 2025 (CN) 202510398663.1

(51) Int. Cl. H04N 19/85

(52) U.S. Cl. CPC H04N 19/85

(57) ABSTRACT

Provided are a coding method, apparatuses and a device. For a synthesis operation of synthesizing multiple media files into one media file, a value of a file parameter of each of the multiple media files is acquired. A value of a coding parameter is determined on the basis of the value of the file parameter of each of the multiple media files, the value of the coding parameter corresponding to the largest value among the values of a corresponding file parameter of each of the multiple media files. The multiple media files are coded according to the value of the coding parameter, to obtain a target media file, which is a result of performing the synthesis operation on the multiple media files.

### CROSS REFERENCE TO RELATED APPLICATIONS

This application is based on and claims priority of CN application with application No. 202510398663.1 filed on Mar. 31, 2025, the entire disclosure of which is hereby incorporated by reference.

### TECHNICAL FIELD

The present application relates to the technical field of media processing and, in particular, to a coding method, an apparatus and a device.

### BACKGROUND

In a process of editing a media file by using a media editing client, a user typically goes through three stages: import, editing and export. After importing a media file in a media editing task and editing the imported media file, the user may obtain an exported file by exporting the media editing task. When the media editing task is exported, coding is usually required to compress the edited media file into a format that may be played on different devices and platforms.

At present, on the media editing client, a default value of a coding parameter used for coding during export is a fixed value. Any media file imported by the user into the media editing task is coded by using the fixed value during export, to obtain the exported file. A value of a file parameter of the exported file is equal to the fixed value of the corresponding coding parameter.

### SUMMARY

The technical solutions provided in the embodiments of the present application are as follows:

In a first aspect of the present application, a coding method is provided, including:
acquiring, in response to a synthesis operation for multiple media files, a value of a file parameter of each of the multiple media files, where the synthesis operation is used for synthesizing the multiple media files into one media file;
determining a value of a coding parameter based on the value of the file parameter of each of the multiple media files, where the value of the coding parameter corresponds to a largest value among values of a corresponding file parameter of each of the multiple media files; and
coding the multiple media files according to the value of the coding parameter, to obtain a target media file, where the target media file is a result of performing the synthesis operation on the multiple media files.

In some implementations, the multiple media files include a first file and a second file, the file parameter and the coding parameter each include a first parameter, a value of the first parameter of the first file is a first value, and a value of a first parameter of the second file is a second value; and determining the value of the coding parameter based on the value of the file parameter of each of the multiple media files includes:
determining, in response to the first value being greater than or equal to the second value, a value of a first parameter in the coding parameter to be the first value.

In some implementations, the multiple media files include a first file and a second file, the file parameter and the coding parameter each include a first parameter, a value of the first parameter of the first file is a first value, and a value of the first parameter of the second file is a second value; and determining the value of the coding parameter based on the value of the file parameter of each of the multiple media files includes:
determining, in response to the first value being greater than the second value and the first value being greater than a target value, a value of a first parameter in the coding parameter to be the target value.

In some implementations, the multiple media files include a first file and a second file, the file parameter and the coding parameter each include a first parameter, a value of the first parameter of the first file is a first value, and a value of a first parameter of the second file is a second value; and determining the value of the coding parameter based on the value of the file parameter of each of the multiple media files includes:
determining, in response to the first value being greater than or equal to the second value, a value of a first parameter in the coding parameter to be a third value according to a preset mapping relationship, where the first value corresponds to the third value in the mapping relationship.

In some implementations, before the synthesis operation is performed, the method further includes:
in response to adding a third file to the synthesis operation, updating a value of the first parameter in the coding parameter to a fifth value corresponding to a fourth value if the fourth value is greater than the value of the first parameter in the coding parameter, where the fourth value is a value of the first parameter in the third file.

In some implementations, before the synthesis operation is performed, the method further includes:
in response to setting a value of the first parameter in the coding parameter to a sixth value, determining the value of the first parameter in the coding parameter to be the sixth value, regardless of the value of the first parameter of each of the multiple media files.

In some implementations, a type of the media file may include a video file, and the file parameter and the coding parameter each include at least one of the following parameters: bit rate, resolution and frame rate.

In some implementations, a type of the media file may include an audio file, and the file parameter and the coding parameter each include at least one of the following parameters: bit rate, sampling rate and bit depth.

In some implementations, the synthesis operation for the multiple media files belongs to an export operation of a media editing task, and the multiple media files are included in the media editing task.

In some implementations, before the multiple media files are coded according to the value of the coding parameter, the method further includes:
displaying the value of the coding parameter; and
acquiring, in response to a confirmation operation or a modification operation of a user on the value of the coding parameter, a target value of the coding parameter; and
coding the multiple media files according to the value of the coding parameter includes:
coding the multiple media files according to the target value of the coding parameter.

In a second aspect of the present application, a coding apparatus is provided, including:
an acquiring unit configured to acquire, in response to a synthesis operation for multiple media files, a value of a file parameter of each of the multiple media files, where the synthesis operation is used for synthesizing the multiple media files into one media file;
a determining unit configured to determine a value of a coding parameter based on the value of the file parameter of each of the multiple media files, where the value of the coding parameter corresponds to a largest value among values of a corresponding file parameter of each of the multiple media files; and
a coding unit configured to code the multiple media files according to the value of the coding parameter, to obtain a target media file, where the target media file is a result of performing the synthesis operation on the multiple media files.

In some implementations, the multiple media files include a first file and a second file, the file parameter and the coding parameter each include a first parameter, a value of the first parameter of the first file is a first value, and a value of a first parameter of the second file is a second value; and the determining unit is further configured to:
determine, in response to the first value being greater than or equal to the second value, a value of a first parameter in the coding parameter to be the first value.

In some implementations, the multiple media files include a first file and a second file, the file parameter and the coding parameter each include a first parameter, a value of the first parameter of the first file is a first value, and a value of the first parameter of the second file is a second value; and the determining unit is further configured to:
determine, in response to the first value being greater than the second value and the first value being greater than a target value, a value of a first parameter in the coding parameter to be the target value.

In some implementations, the multiple media files include a first file and a second file, the file parameter and the coding parameter each include a first parameter, a value of the first parameter of the first file is a first value, and a value of a first parameter of the second file is a second value; and the determining unit is further configured to:
determine, in response to the first value being greater than or equal to the second value, a value of a first parameter in the coding parameter to be a third value according to a preset mapping relationship, where the first value corresponds to the third value in the mapping relationship.

In some implementations, the apparatus further includes: an updating unit.

The updating unit is configured to, before the synthesis operation is performed, in response to adding a third file to the synthesis operation, update a value of the first parameter in the coding parameter to a fifth value corresponding to a fourth value if the fourth value is greater than the value of the first parameter in the coding parameter, where the fourth value is a value of the first parameter in the third file.

In some implementations, the determining unit is further configured to, before the synthesis operation is performed, in response to setting a value of the first parameter in the coding parameter to a sixth value, determine the value of the first parameter in the coding parameter to be the sixth value, regardless of a value of the first parameter of each of the multiple media files.

In some implementations, a type of the media file may include a video file, and the file parameter and the coding parameter each include at least one of the following parameters: bit rate, resolution and frame rate.

In some implementations, a type of the media file may include an audio file, and the file parameter and the coding parameter each include at least one of the following parameters: bit rate, sampling rate and bit depth.

In some implementations, the synthesis operation for the multiple media files belongs to an export operation of a media editing task, and the multiple media files are included in the media editing task.

In some implementations, the apparatus further includes: a displaying unit and an operating unit.

The displaying unit is configured to, before the multiple media files are coded according to the value of the coding parameter, display the value of the coding parameter;
the operating unit is configured to acquire, in response to a confirmation operation or a modification operation of a user on the value of the coding parameter, a target value of the coding parameter; and
the coding unit is further configured to:
edit the multiple media files according to the target value of the coding parameter.

It should be noted that, for a specific implementation of the apparatus and technical effects achieved, reference may be made to the relevant description of the method provided in the first aspect or any implementation of the first aspect.

In a third aspect of the present application, an electronic device is provided, and the electronic device includes: a processor and a memory, where the memory is configured to store an instruction or a computer program, and the processor is configured to execute the instruction or the computer program in the memory, to cause the electronic device to perform the method provided in the first aspect or any implementation of the first aspect.

In a fourth aspect of the present application, a computer-readable storage medium is provided, where an instruction is stored in the computer-readable storage medium, and the instruction, when run on a processor, causes the processor to perform the method provided in the first aspect or any implementation of the first aspect.

In a fifth aspect of the present application, a computer program product is provided, and the computer program product includes a computer program or an instruction, where the method provided in the first aspect or any implementation of the first aspect is implemented when the computer program or the instruction is executed by a processor.

In the present application, a coding method is provided, and the method may include, for example, that: for a synthesis operation of synthesizing multiple media files into one media file, a media editing client first acquires a value of a file parameter of each of the multiple media files; then determines a value of a coding parameter based on the value of the file parameter of each of the multiple media files, where the value of the coding parameter corresponds to a largest value among values of a corresponding file parameter of each of the multiple media files; and thus codes each of the multiple media files according to the value of the coding parameter, to obtain a target media file, where the target media file is a result of performing the synthesis operation on the multiple media files.

### BRIEF DESCRIPTION OF THE DRAWINGS

In order to more clearly describe the technical solutions in the embodiments of the present application or in the related art, the following briefly introduces the drawings required for describing the embodiments or the related art. Apparently, the drawings in the following description show merely some embodiments of the present application, and a person of ordinary skill in the art may still derive other drawings from these drawings without creative efforts.

FIG. 1 is a schematic flowchart of coding during export of a media editing task at present;

FIG. 2 is a schematic flowchart of a coding method according to an embodiment of the present application;

FIG. 3 is a schematic flowchart of an example of a coding method according to an embodiment of the present application;

FIG. 4 is a schematic diagram of a structure of a coding apparatus 400 according to an embodiment of the present application; and

FIG. 5 is a schematic diagram of a structure of an electronic device 500 according to an embodiment of the present application.

### DETAILED DESCRIPTION OF EMBODIMENTS

In order to enable persons skilled in the art to better understand the solutions of the present application, the technical solutions in the embodiments of the present application are described below clearly and completely with reference to the drawings in the embodiments of the present application. Apparently, the described embodiments are merely some rather than all of the embodiments of the present application. All other embodiments obtained by a person of ordinary skill in the art based on the embodiments of the present application without creative efforts shall fall within the scope of protection of the present application.

First, some concepts involved in the embodiments of the present application are briefly introduced.

A media editing client refers to a client used for editing media files including videos, audios, etc. A user may install the media editing client on a terminal device and use the media editing client. The coding method provided in the embodiments of the present application may be a procedure performed when any media editing task is exported on the media editing client, and is an inevitable procedure for implementing export of an edited media file.

A media editing task may be understood as a task that exists on the media editing client and corresponds to a process when the user edits a media file once by using the media editing client. The media editing task may correspond to a draft on the media editing client. In the media editing task, the user may import a media file, edit the imported media file, or perform export when considering that the editing is completed. The media editing task may use completion of the export as a sign of task completion.

A media file may be any type of file that may be edited by the media editing client, and for example, the media file may include but is not limited to a video file and/or an audio file.

The file parameter of the media file may refer to a factor that may affect quality, export speed (which may also be referred to as compression efficiency), and file size of the media file. The quality of the media file may be understood as a viewing or listening experience that the user may perceive, such as clarity and smoothness of the media file.

The file parameter of the video file may include: bit rate, resolution and frame rate. The bit rate refers to the number of bits transmitted per second, and is usually measured in kilobits per second (kbps) or megabits per second (Mbps). With other factors being the same, a higher bit rate usually leads to better video quality and larger file size. The resolution refers to a pixel size of a video frame, and is usually represented by width×height, for example, 1920×1080 represents a resolution of full high-definition (Full HD). On the media editing client, the resolution of the video file may be represented only by the height, for example, in the case where the aspect ratio is 16:9, 1920×1080 may be represented as 1080P, and 1280×720 may be represented as 720P. With other factors being the same, a higher resolution leads to better video quality and larger file size. The frame rate refers to the number of video frames displayed per second, and is usually measured in frames per second (fps). Common frame rates are, for example, 24 fps, 30 fps and 60 fps. With other factors being the same, a higher frame rate leads to better video quality (e.g., smoother) but also larger file size.

The file parameter of the audio file may include: sampling rate, bit depth and bit rate. The sampling rate determines the temporal resolution of the audio. The higher the sampling rate, the richer the sound details that may be captured, and the higher the fidelity of the audio. With other factors being the same, a higher sampling rate may better restore high-frequency components in the original sound, allowing the human ears to hear more subtle sound changes, such as overtones of musical instruments, making the audio sound clearer and more natural, that is, the better the audio quality, but the larger the file size. The bit depth, also known as sampling precision, refers to the number of bits used for each sampling point. Common bit depths are, for example, 8 bits, 16 bits, 24 bits, etc. The higher the bit depth, the wider the range of sound amplitudes that may be represented, and the greater the dynamic range of the audio. With other factors being the same, a higher bit depth may reduce quantization errors, making the audio quieter at low volume, fuller at high volume, and more excellent in sound layering and detail performance, that is, the better the audio quality, but the larger the file size. The bit rate refers to the number of bits occupied by audio data per unit time, and is usually measured in bits per second (bps). The bit rate is used to measure the data transmission rate or storage density after audio coding. A higher bit rate means a larger amount of audio data transmitted or stored per unit time. With other factors being the same and in the same coding format, a higher bit rate may provide more data for the audio coding to represent the sound signal, thereby reducing information loss during compression and making the audio closer to the original sound, that is, the better the audio quality, but the larger the file size.

The coding parameter of the media file may refer to a parameter used for coding an edited media file when multiple media files are synthesized into one media file (for example, when a media editing task including the multiple media files is exported). The coding parameter is used for performing processing such as compression on the multiple media files to be synthesized. Usually, a value of the coding parameter determines a file parameter of the synthesized file (such as a media file exported from the media editing task). Therefore, the value of the coding parameter may determine the quality of the exported file, the export speed and the file size of the exported file. “Export” in the following may be understood as an example of “synthesis”.

The coding parameter of the video file may include: bit rate, resolution and frame rate. With other factors being the same, a higher bit rate usually leads to better video quality of the exported file, slower export speed, and larger file size. With other factors being the same, a higher resolution leads to better video quality of the exported file, slower export speed, and larger file size. With other factors being the same, a higher frame rate leads to better video quality (e.g., smoother) of the exported file, but slower export speed and larger file size. Similarly, the coding parameter of the audio file may include: sampling rate, bit depth and bit rate. With other factors being the same, a higher sampling rate leads to better audio quality of the exported file, but slower export speed and larger file size. With other factors being the same, a higher bit depth leads to better audio quality of the exported file, but slower export speed and larger file size. With other factors being the same and in the same coding format, a higher bit rate leads to better audio quality of the exported file, but slower export speed and larger file size.

It may be understood that, with other factors being the same, the larger the value of a file parameter of a media file, the higher the quality of the media file, and the larger the size of the media file. When an edited media file is exported, with other factors being the same, for a coding parameter, within a range of values less than or equal to a value of a corresponding file parameter, the larger the value of the coding parameter, the better the quality of the exported file, but the slower the export speed, and the larger the size of the exported file.

At present, on the media editing client, a value of a coding parameter used for coding is a default fixed value. For example, when a user uses the media editing client, the user may import multiple media files into a draft corresponding to a created media editing task, edit the imported media files, and obtain an exported file corresponding to the media editing task by exporting after the editing is completed. When the media editing task is exported, the edited media file is coded according to the default fixed value, to obtain the exported file in a format that may be played on different devices and platforms. However, the manner of performing coding by using the default fixed value on the media editing client is not reasonable for many media editing tasks, and a balance between quality of the exported file and an export speed cannot be achieved.

It is found through research that the manner of coding with the coding parameter being the default fixed value is not reasonable for many scenarios. For example, a default fixed value of a coding parameter, that is, video resolution, is 1080P, and in the case where a largest resolution of a video included in a media editing task is 720P, 1080P is used for coding. Taking a 20-second 720P video as an example, the video is coded by using 720P and 1080P separately, and the export speed and the file size of the exported file may be seen from the following Table 1.

TABLE 1

| Resolution in coding | Export | File size of |
|---|---|---|
| parameter | speed | exported file |
| 1080P | 5.45 seconds | 32.6 MB |
| 720P | 3.26 seconds | 19.1 MB |
| Rate of change | −40.18% | −41.41% |

It may be seen that, compared with coding by using 720P, coding the video by using a resolution of 1080P leads to slower export speed and larger exported file, however, the video quality is not improved by using a higher resolution for coding.

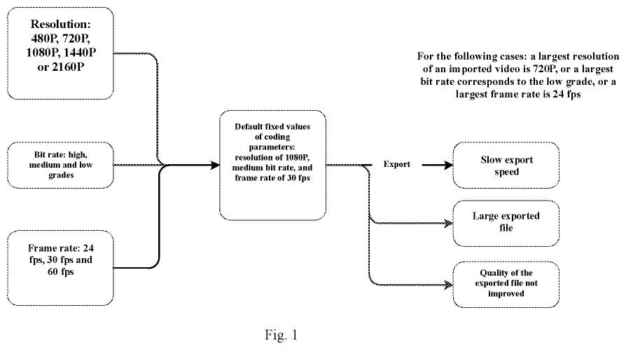

As shown in FIG. 1, a video in a media editing task may have a resolution of 480P, 720P, 1080P, 1440P (which may also be referred to as 2K) or 2160P (which may also be referred to as 4K), a bit rate that may be divided into high, medium and low grades according to certain rules, and a frame rate of 24 fps, 30 fps and 60 fps. Default fixed values of coding parameters on a media editing client may be: a resolution of 1080P, a medium bit rate, and a frame rate of 30 fps. The edited video in the media editing task is coded with a resolution of 1080P, a medium bit rate and a frame rate of 30 fps. If a largest resolution of an imported video in the media editing task is 720P, or a largest bit rate corresponds to the low grade, or a largest frame rate is 24 fps, the video quality of the obtained exported video is not improved, instead, the export speed becomes slower and the file size of the exported video becomes larger.

In view of this, embodiments of the present application provide a coding method, an apparatus and a device. A more reasonable value of a coding parameter is determined in a targeted manner based on a value of a file parameter of a media file imported in a media editing task, and an export speed may be increased as much as possible while quality of an exported file is retained.

Based on this, in order to maximize the export speed and reduce the file size of the exported file without affecting the quality of the exported file exported from the media editing task, an embodiment of the present application provides a coding method. The method flexibly and intelligently determines a coding parameter for a synthesis operation based on file parameters of multiple media files to be synthesized. As an example, the method may include, for example, that: for the synthesis operation of the multiple media files, a media editing client first acquires a value of a file parameter of each of the multiple media files; then determines a value of a coding parameter based on the value of the file parameter of each of the multiple media files, where the value of the coding parameter corresponds to a largest value among values of a corresponding file parameter of each of the multiple media files; and thus codes each of the multiple media files according to the value of the coding parameter to obtain a target media file, where the target media file is a result of performing the synthesis operation on the multiple media files.

In this way, with the method, for the synthesis operation of synthesizing the multiple media files into one media file, the media editing client does not generally use a default fixed value for all synthesis operations, but acquires the value of the file parameter of each of the multiple media files, and reasonably determines, for each parameter in the file parameter, a value of the parameter in the coding parameter based on the largest value among values of the parameter of each of the multiple media files. Since the value of the coding parameter is based on the largest value among values of a corresponding parameter in each of the multiple media files, a synthesis speed may be increased as much as possible and a size of the target media file may be reduced as much as possible while ensuring quality of the synthesized target media file.

The synthesis operation may be an export operation of a media editing task, and the media file may be a file imported in the media editing task (which may also be understood as a draft corresponding to the media editing task). In the following, the export operation of the media editing task being the synthesis operation is used as an example for description.

For example, in the case where a largest resolution of an imported video in the media editing task is 720P, a largest bit rate corresponds to a low grade, and a largest frame rate is 24 fps, based on the method provided in the embodiments of the present application, the value of the coding parameter is determined to include: a resolution of 720P, a bit rate of the low grade, and a frame rate of 24 fps. Compared with the manner of coding with the coding parameter being the default fixed value as shown in FIG. 1, not only the quality of the exported file does not decline, but also the export speed is improved and the exported file is smaller.

It should be noted that a subject performing the coding method may be a coding apparatus provided in an embodiment of the present application. The coding apparatus may be carried in an electronic device or a functional module of the electronic device. The coding apparatus may be, for example, a functional module on a network device such as a server or a terminal device such as a mobile phone, and the functional module is configured to implement the coding function provided in the embodiments of the present application. For example, the coding apparatus may be a module on a media editing client on the terminal device, and the module is configured to implement the coding function provided in the embodiments of the present application.

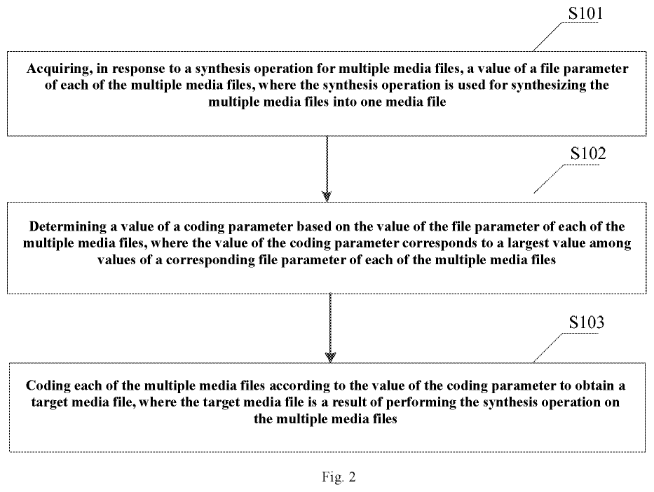

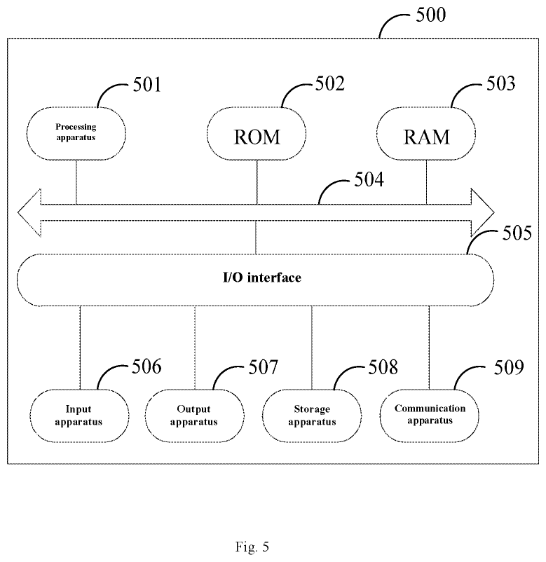

FIG. 2 is a schematic flowchart of a coding method provided in an embodiment of the present application. The method may be applied to a coding apparatus, and the coding apparatus may be, for example, a coding apparatus 400 shown in FIG. 4 below.

As shown in FIG. 2, the method may include the following S101 to S103, for example:

S101, acquiring, in response to a synthesis operation for multiple media files, a value of a file parameter of each of the multiple media files, where the synthesis operation is used for synthesizing the multiple media files into one media file.

As an example, the synthesis operation for the multiple media files may belong to an export operation of a media editing task, for example, and the multiple media files in S101 may be included in the media editing task. In the following, the export operation of the media editing task being the synthesis operation is used as an example for description.

In a draft corresponding to the media editing task, an imported media file corresponds to metadata, and the metadata is used for describing various attributes (or features) of the media file. As an example, S101 may include, for example, that: a coding apparatus acquires metadata of each imported media file in the draft corresponding to the media editing task; and reads the file parameter of each imported media file and the corresponding value based on the metadata.

A type of the media file may include a video file or an audio file. For the video file, the file parameter may include at least one of the following parameters: bit rate, resolution and frame rate, and the coding parameter and a file parameter of the exported file correspond to the file parameter of the imported video file. For the audio file, the file parameter may include at least one of the following parameters: bit rate, sampling rate and bit depth, and the coding parameter and the file parameter of the exported file correspond to the file parameter of the imported audio file.

After S101, preparation work is completed for determining a reasonable value of the coding parameter by referring to the value of the file parameter of each of the multiple media files, which makes it possible to perform better coding based on the reasonable value of the coding parameter.

S102, determining a value of a coding parameter based on the value of the file parameter of each of the multiple media files, where the value of the coding parameter corresponds to a largest value among values of a corresponding file parameter of each of the multiple media files.

It should be noted that “corresponding” in S102 may be understood as a value whose difference from the largest value is within a preset range, and the preset range is small enough. For example, a largest resolution of each of the multiple media files is 720P, and the resolution in the coding parameter may be 720P, or 720P±10P (a small enough preset value), but 1080P does not belong to the value corresponding to 720P. For another example, a largest bit rate of each of the multiple media files is 4 Mbps, and the bit rate in the coding parameter may be 4 Mbps, or 4 Mbps±0.5 Mbps (a small enough preset value), but 84 Mbps does not belong to the value corresponding to 4 Mbps.

In some possible implementations, S102 may include: acquiring, for each file parameter, a largest value among values of the file parameter of each of the multiple media files, and determining, based on the largest value, a coding value of the file parameter (that is, a value of a coding parameter corresponding to the file parameter). In this way, on the premise that the quality of the exported file is ensured, coding is performed with a coding parameter with a smaller value as much as possible, so that the export speed is as fast as possible and the size of the exported file is as small as possible, thereby improving the user experience of using the media editing client.

As an example, assuming that the multiple media files include a first file and a second file, the file parameter and the coding parameter each include a first parameter, a value of the first parameter of the first file is a first value, and a value of the first parameter of the second file is a second value, S102 may include: if the first value is greater than or equal to the second value, determining a value of the first parameter in the coding parameter to be the first value; and if the first value is less than the second value, determining the value of the first parameter in the coding parameter to be the second value.

For example, the media files imported in the media editing task include a video 1 and a video 2, where a resolution of the video 1 is 480P and a resolution of the video 2 is 720P, then a largest resolution of the video 1 and the video 2 is determined to be 720P, and a value of resolution in a coding parameter when the media editing task is exported is determined to be 720P.

As another example, still assuming that the multiple media files include a first file and a second file, the file parameter and the coding parameter each include a first parameter, a value of the first parameter of the first file is a first value, and a value of the first parameter of the second file is a second value, S102 may include: if the first value is greater than the second value and the first value is greater than a target value, determining a value of the first parameter in the coding parameter to be the target value. The target value may be a more general value of the corresponding coding parameter, and may be flexibly set based on experience or requirements, for example, determined after comprehensively considering the quality of the exported file, the file size of the exported file and the export speed. The target value may be, for example, a current default fixed value of the coding parameter. This example is applicable to the case where a parameter value is too large in the multiple imported media files. With the preset target value in the method, the problem of excessive overheads caused by coding with an excessively large coding parameter value as a whole due to an outstanding parameter value of some imported media files may be avoided. For example, when a media editing task including numerous 720P and below videos and one 2K video is exported, although coding with a resolution of 2K may ensure that the exported video has a high quality, the export speed is extremely slow and the exported file is extremely large, which is not friendly to balancing the quality of the exported file, the export speed and the file size of the exported file.

For example, for the resolution, a preset target value is 1080P, and the media files imported in the media editing task include a video 1, a video 2 and a video 3, where a resolution of the video 1 is 720P, a resolution of the video 2 is 1080P, and a resolution of the video 3 is 1440P. Then, a largest resolution of the video 1, the video 2 and the video 3 is determined to be 1440P, but 1440P is greater than the target value of 1080P, and a value of the resolution in the coding parameter when the media editing task is exported is determined to be 1080P.

As yet another example, still assuming that the multiple media files include a first file and a second file, the file parameter and the coding parameter each include a first parameter, a value of the first parameter of the first file is a first value, and a value of a first parameter of the second file is a second value, S102 may include: if the first value is greater than or equal to the second value, determining a value of the first parameter in the coding parameter to be a third value according to a preset mapping relationship, where the first value corresponds to the third value in the mapping relationship. In this example, the mapping relationship may be designed according to requirements or experience, and the mapping relationship may be used for determining a value of the coding parameter corresponding to a largest value of the file parameter of each of the multiple media files. For example, the mapping relationship may be a correspondence between a value range of the file parameter and a value of the coding parameter, or may be a correspondence among a value range of the file parameter, a grade and a value of the coding parameter, or may be a correspondence 1 between a value range of the file parameter and a grade+a correspondence 2 between the grade and a value of the coding parameter.

For example, for the bit rate, it is assumed that 0 Mbps to 2 Mbps corresponds to a low grade, 2 Mbps to 4 Mbps corresponds to a medium grade, and greater than 4 Mbps corresponds to a high grade, where the low grade corresponds to a coding parameter value of 2.1 Mbps, the medium grade corresponds to a coding parameter value of 4.1 Mbps, and the high grade corresponds to a coding parameter value of 10 Mbps. The media files imported in the media editing task include a video 1, a video 2 and a video 3, where a bit rate of the video 1 is 1.2 Mbps, a bit rate of the video 2 is 3.5 Mbps, and a bit rate of the video 3 is 2.7 Mbps. Then, a largest bit rate of the video 1, the video 2 and the video 3 is determined to be 3.5 Mbps, and 3.5 Mbps falls within the range of 2 Mbps to 4 Mbps, corresponding to the medium grade. Thus, a value of the bit rate in the coding parameter when the media editing task is exported is determined to be 4.1 Mbps corresponding to the medium grade.

After S102, a more reasonable value of the coding parameter is determined in a targeted manner based on the value of the file parameter of each of the multiple media files to be synthesized, which provides a data basis for performing coding in the synthesis operation in S103.

S103, coding each of the multiple media files according to the value of the coding parameter to obtain a target media file, where the target media file is a result of performing the synthesis operation on the multiple media files.

For example, the synthesis operation is the export operation of the media editing task, and the media editing task includes a video 1, a video 2, a video 3, an audio 1 and an audio 2. Values of the bit rate, the resolution and the frame rate of the video 1, the video 2 and the video 3 are acquired based on the above S101 separately, and based on the above S102, values of corresponding coding parameters of the video determined based on the values of the bit rate, the resolution and the frame rate of the video 1, the video 2 and the video 3 are: a bit rate of 4.1 Mbps, a resolution of 720P, and a frame rate of 30 fps. Then, when the media editing task is exported, the video 1, the video 2 and the video 3 are coded based on the values of the coding parameters corresponding to the video, to obtain the video included in the exported file. Similarly, values of the sampling rate, the bit rate and the bit depth of the audio 1 and the audio 2 are acquired based on the above S101 separately, and based on the above S102, values of the coding parameters corresponding to the audio are determined based on the values of the sampling rate, the bit rate and the bit depth of the audio 1 and the audio 2. Then, when the media editing task is exported, the audio 1 and the audio 2 are coded based on the values of the coding parameters corresponding to the audio, to obtain the audio included in the exported file.

In the following, some possible implementations of the embodiments of the present application are described by using an example in which the synthesis operation is the export operation of the media editing task.

In some possible implementations, if before S103 and after S102, the user imports a new media file into the draft corresponding to the media editing task based on the design of the media editing task, the coding apparatus may acquire a value of a file parameter of the new media file, and determine, based on the value of the file parameter of the new media file and the already determined value of the coding parameter, whether the value of the coding parameter needs to be updated, so that the value of the coding parameter used when the media coding task is exported is still reasonable for the media editing task added with the new media file.

As an example, still assuming that the multiple media files include a first file and a second file, the file parameter and the coding parameter each include a first parameter, a value of the first parameter of the first file is a first value, and a value of a first parameter of the second file is a second value, the method may further include: in response to adding a third file to the media editing task, where a value of the first parameter of the third file is a fourth value, if the fourth value is greater than a value of the first parameter in the coding parameter (that is, a value determined based on values of the first parameter in the file parameter of the first file and the second file), updating the value of the first parameter in the coding parameter to a fifth value corresponding to the fourth value. The fifth value may be equal to the fourth value, or the fifth value may be equal to a value corresponding to the fourth value in the mapping relationship, or the fifth value may be equal to the target value.

For example, the media files imported in the media editing task include a video 1 and a video 2, and before S103, a resolution in a coding parameter determined based on S102 is 720P. The user imports a video 3 into the media editing task, and a resolution of the video 3 is 1080P. Then, since 1080P is greater than 720P, the value of the resolution in the coding parameter may be updated based on 1080P, for example, the value of the resolution in the coding parameter may be updated to 1080P.

In some other possible implementations, in order to highlight the priority of manual setting by the user, if the user manually sets the value of the coding parameter during the existence of the media editing task (including after the media editing task is created and before the media editing task is exported), the value of the file parameter of the imported media file may not be considered, and the value of the coding parameter set by the user shall prevail, and the edited media file in the media editing task is coded.

As an example, still assuming that the multiple media files include a first file and a second file, the file parameter and the coding parameter each include a first parameter, a value of the first parameter of the first file is a first value, and a value of a first parameter of the second file is a second value, the method may further include: in response to setting a value of the first parameter in the coding parameter of the media editing task to a sixth value, determining the value of the first parameter in the coding parameter to be the sixth value; and after the value of the first parameter is determined to be the sixth value, the value of the first parameter is no longer affected by the value of the file parameter of the imported media file added to or deleted from the media editing task, and is only affected by manual setting by the user again. In this way, the method not only provides the solution of intelligently determining the value of the coding parameter, but also combines the user operation, so that the technical solution takes into account both user requirements and intelligence.

For example, the media files imported in the media editing task include a video 1 and a video 2, and before S103, a resolution in a coding parameter determined based on S102 is 1080P. Assuming that a resolution of the video 2 is 2K, if the user does not want to reduce the export quality of the video 2 and does not care about ensuring the quality of the exported file with a slower export speed and a larger size of the exported file, the user may manually set the resolution in the coding parameter to 2K on the media editing client. Thus, the resolution in the coding parameter when the media editing task is exported is determined to be 2K, and S103 includes coding the edited media file in the media editing task with a resolution of 2K.

It should be noted that in the draft corresponding to the media editing task, the media file imported in the media editing task still exists in the draft, so after the draft is reopened after being exited, a reasonable coding parameter may still be determined by the method provided in the embodiments of the present application based on the value of the file parameter of the media file in the draft.

In some possible implementations, in order to improve the user's sense of participation during the synthesis operation, thereby improving the user experience of using the media editing client, before S103 and after S102, the method may further include: displaying the value of the coding parameter determined based on S102; and acquiring, in response to a confirmation operation or a modification operation of the user on the value of the coding parameter, a target value of the coding parameter. Then, S103 may specifically include: coding the multiple media files according to the target value of the coding parameter. In one case, if the user confirms the displayed value of the coding parameter (that is, does not modify the value of any coding parameter), the target value used for coding in S103 is the value determined in S102. In another case, if the user modifies all or part of the displayed value of the coding parameter, the target value used for coding in S103 is the value modified by the user. In this way, the coding apparatus may present the reasonable value of the coding parameter determined based on the method to the user for confirmation or modification, which implements a dual design of intelligent recommendation+user confirmation, so that a reasonable coding parameter may be provided and user requirements may be met as much as possible.

It may be seen that with the method, for the synthesis operation for the multiple media files, the media editing client does not generally use the default fixed value, but acquires the value of the file parameter of each of the multiple media files in the synthesis operation, and reasonably determines, for each parameter in the file parameter, the value of the parameter in the coding parameter based on the largest value among values of the parameter of each of the multiple media files. Since the value of the coding parameter is based on the largest value among values of a corresponding parameter in each of the multiple media files, the synthesis speed may be increased as much as possible and the size of the synthesized target media file may be reduced as much as possible while ensuring the quality of the synthesized target media file.

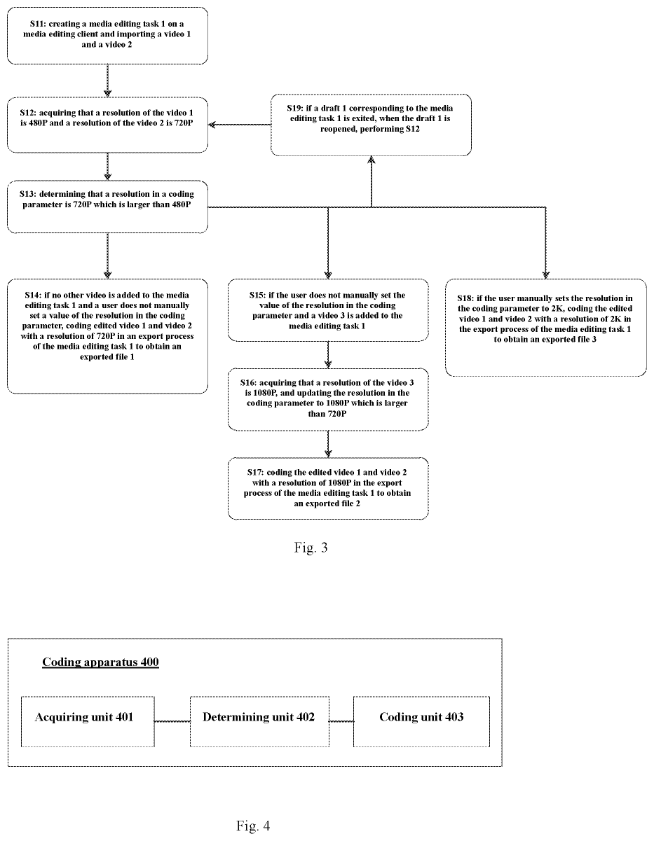

In order to make the method provided in the embodiments of the present application clearer, an example is introduced below in conjunction with FIG. 3.

As shown in FIG. 3, taking the export of a media editing task including multiple media files, the media file being a video, and a resolution in a file parameter and a coding parameter of the video as an example, this example may include:
S11, creating a media editing task 1 on a media editing client and importing a video 1 and a video 2;
S12, acquiring that a resolution of the video 1 is 480P and a resolution of the video 2 is 720P;
S13, determining that a resolution in the coding parameter is 720P which is larger than 480P; then, performing the following S14, S15, S18 or S19 according to different situations:
S14, if no other video is added to the media editing task 1 and a user does not manually set a value of the resolution in the coding parameter, coding edited video 1 and video 2 with a resolution of 720P in an export process of the media editing task 1, to obtain an exported file 1;
S15, if the user does not manually set the value of the resolution in the coding parameter and a video 3 is added to the media editing task 1, performing S16 to S17;
S16, acquiring that a resolution of the video 3 is 1080P, and updating the resolution in the coding parameter to 1080P which is larger than 720P;
S17, coding the edited video 1 and video 2 with a resolution of 1080P in the export process of the media editing task 1, to obtain an exported file 2;
S18, if the user manually sets the resolution in the coding parameter to 2K, coding the edited video 1 and video 2 with a resolution of 2K in the export process of the media editing task 1, to obtain an exported file 3; and
S19, if a draft 1 corresponding to the media editing task 1 is exited, performing S12 when the draft 1 is reopened.

It may be seen that with the method, a balance between the quality of the exported file and the export speed is achieved, and the export speed may be increased as much as possible and the size of the exported file may be reduced as much as possible while maintaining the quality of the exported file.

Correspondingly, an embodiment of the present application further provides a coding apparatus 400, as shown in FIG. 4. The apparatus 400 may include:
an acquiring unit 401, configured to acquire, in response to a synthesis operation for multiple media files, a value of a file parameter of each of the multiple media files, where the synthesis operation is used for synthesizing the multiple media files into one media file;
a determining unit 402, configured to determine a value of a coding parameter based on the value of the file parameter of each of the multiple media files, where the value of the coding parameter corresponds to a largest value among values of a corresponding file parameter of each of the multiple media files; and
a coding unit 403, configured to code the multiple media files according to the value of the coding parameter to obtain a target media file, where the target media file is a result of performing the synthesis operation on the multiple media files.

In some implementations, the multiple media files include a first file and a second file, the file parameter and the coding parameter each include a first parameter, a value of the first parameter of the first file is a first value, and a value of a first parameter of the second file is a second value; and the determining unit 402 is further configured to:
determine, in response to the first value being greater than or equal to the second value, a value of a first parameter in the coding parameter to be the first value.

In some implementations, the multiple media files include a first file and a second file, the file parameter and the coding parameter each include a first parameter, a value of the first parameter of the first file is a first value, and a value of the first parameter of the second file is a second value; and the determining unit 402 is further configured to:
determine, in response to the first value being greater than the second value and the first value being greater than a target value, a value of a first parameter in the coding parameter to be the target value.

In some implementations, the multiple media files include a first file and a second file, the file parameter and the coding parameter each include a first parameter, a value of the first parameter of the first file is a first value, and a value of a first parameter of the second file is a second value; and the determining unit 402 is further configured to:
determine, in response to the first value being greater than or equal to the second value, a value of a first parameter in the coding parameter to be a third value according to a preset mapping relationship, where the first value corresponds to the third value in the mapping relationship.

In some implementations, the apparatus 400 further includes: an updating unit.

The updating unit is configured to, before the synthesis operation is performed, in response to adding a third file to the synthesis operation, update a value of the first parameter in the coding parameter to a fifth value corresponding to a fourth value if the fourth value is greater than the value of the first parameter in the coding parameter, where the fourth value is a value of the first parameter in the third file.

In some implementations, the determining unit 402 is further configured to, before the synthesis operation is performed, in response to setting a value of the first parameter in the coding parameter to a sixth value, determine the value of the first parameter in the coding parameter to be the sixth value, regardless of a value of the first parameter of each of the multiple media files.

In some implementations, a type of the media file may include a video file, and the file parameter and the coding parameter each include at least one of the following parameters: bit rate, resolution and frame rate.

In some implementations, a type of the media file may include an audio file, and the file parameter and the coding parameter each include at least one of the following parameters: bit rate, sampling rate and bit depth.

In some implementations, the synthesis operation for the multiple media files belongs to an export operation of a media editing task, and the multiple media files are included in the media editing task.

In some implementations, the apparatus 400 further includes: a displaying unit and an operating unit.

The displaying unit is configured to, before the multiple media files are coded according to the value of the coding parameter, display the value of the coding parameter;
the operating unit is configured to acquire, in response to a confirmation operation or a modification operation of a user on the value of the coding parameter, a target value of the coding parameter; and
the coding unit 403 is further configured to:
edit the multiple media files according to the target value of the coding parameter.

It should be noted that, for a specific implementation of the apparatus 400 and technical effects achieved, reference may be made to the relevant description of the method provided in the embodiments of the present application.

In addition, an embodiment of the present application further provides an electronic device, and the electronic device includes a processor and a memory: the memory is configured to store an instruction or a computer program, and the processor is configured to execute the instruction or the computer program in the memory, to cause the electronic device to perform any implementation of the method provided in the embodiments of the present application.

Referring to FIG. 5, it shows a schematic diagram of a structure of an electronic device 500 suitable for implementing the embodiments of the present disclosure. The terminal device in the embodiments of the present disclosure may include, but is not limited to, mobile terminals such as mobile phones, notebooks, digital broadcast receivers, personal digital assistants (PDA), tablet personal computers (PAD), portable media players (PMP), vehicle terminals (such as car navigation terminal) and the like, and fixed terminals such as digital TVs, desktop computers and the like. The electronic device shown in FIG. 5 is merely an example, and should not impose any limitation on the function and scope of use of the embodiments of the present disclosure.

As shown in FIG. 5, the electronic device 500 may include a processing apparatus (such as a central processing unit, a graphics processor and the like) 501, which may perform various suitable actions and processes according to a program stored in a read-only memory (ROM) 502 or a program loaded from a storage apparatus 508 into a random access memory (RAM) 503. In the RAM 503, various programs and data required for operations of the electronic device 500 are also stored. The processing apparatus 501, the ROM 502 and the RAM 503 are connected to each other through a bus 504. An input/output (I/O) interface 505 is also connected to the bus 504.

Usually, the following apparatuses may be connected to the I/O interface 505: an input apparatus 506 including, for example, a touch screen, a touchpad, a keyboard, a mouse, a camera, a microphone, an accelerometer, a gyroscope and the like; an output apparatus 507 including, for example, a liquid crystal display (LCD), a speaker, a vibrator and the like; the storage apparatus 508 including, for example, a magnetic tape, a hard disk and the like; and a communication apparatus 509. The communication apparatus 509 may allow the electronic device 500 to perform wireless or wired communication with other devices to exchange data. Although FIG. 5 shows the electronic device 500 having various apparatuses, it should be understood that not all the apparatuses shown herein need to be implemented or provided. Alternatively, more or fewer apparatuses may be implemented or provided.

In particular, according to the embodiments of the present disclosure, the procedure described above with reference to the flowchart may be implemented as a computer software program. For example, the embodiments of the present disclosure include a computer program product, which includes a computer program carried on a non-transitory computer-readable medium, where the computer program contains program code for performing the method shown in the flowchart. In such an embodiment, the computer program may be downloaded and installed from a network through the communication apparatus 509, or installed from the storage apparatus 508, or installed from the ROM 502. When the computer program is executed by the processing apparatus 501, the functions defined in the method of the embodiments of the present disclosure are executed.

The electronic device provided in the embodiments of the present disclosure belongs to the same inventive concept as the method provided in the above embodiments. For technical details not described in detail in this embodiment, reference may be made to the above embodiments, and this embodiment has the same beneficial effects as the above embodiments.

An embodiment of the present application further provides a computer-readable medium, where an instruction or a computer program is stored in the computer-readable medium, and the instruction or the computer program, when run on a device, causes the device to perform any implementation of the method provided in the embodiments of the present application.

It should be noted that the computer-readable medium in the present disclosure may be a computer-readable signal medium, a computer-readable storage medium, or any combination thereof. The computer-readable storage medium may be, for example, but is not limited to, an electronic, magnetic, optical, electromagnetic, infrared, or semiconductor system, apparatus or device, or any suitable combination of the above. More specific examples of the computer-readable storage medium may include, but are not limited to: an electrical connection having one or more wires, a portable computer magnetic disk, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination of the above. In the present disclosure, the computer-readable storage medium may be any tangible medium that contains or stores a program, and the program may be used by or in combination with an instruction execution system, apparatus or device. In the present disclosure, the computer-readable signal medium may include a data signal propagated on a baseband or as a part of a carrier wave, and computer-readable program code is carried in the data signal. The data signal propagated in this manner may be in multiple forms, and includes, but is not limited to, an electromagnetic signal, an optical signal, or any suitable combination thereof. The computer-readable signal medium may also be any computer-readable medium other than the computer-readable storage medium, and the computer-readable signal medium may send, propagate or transmit a program for use by or in combination with an instruction execution system, apparatus or device. The program code contained on the computer-readable medium may be transmitted by any suitable medium, including, but not limited to: a wire, an optical cable, a radio frequency (RF), etc., or any suitable combination of the above.

The computer-readable medium may be contained in the electronic device or may exist alone without being assembled into the electronic device.

The computer-readable medium carries one or more programs, and the one or more programs, when executed by the electronic device, cause the electronic device to perform the method described above.

The computer program code for performing the operations of the present disclosure may be written in one or more programming languages or a combination thereof, where the programming languages include but are not limited to object-oriented programming languages such as Java, Smalltalk, C++, and further include conventional procedural programming languages such as “C” language or similar programming languages. The program code may be completely executed on a computer of a user, partially executed on a computer of a user, executed as an independent software package, partially executed on a computer of a user and partially executed on a remote computer, or completely executed on a remote computer or server. In the case of involving a remote computer, the remote computer may be connected to a computer of a user through any kind of network, including a local area network (LAN) or a wide area network (WAN), or may be connected to an external computer (for example, connected through the Internet with the aid of an Internet service provider).

The flowcharts and block diagrams in the drawings illustrate the possibly implemented architectures, functions and operations of the system, the method and the computer program product according to various embodiments of the present disclosure. In this regard, each block in the flowchart or block diagram may represent a module, program segment, or part of code, which contains one or more executable instructions for implementing the specified logical functions. It should also be noted that, in some alternative implementations, the functions marked in the blocks may also occur in an order different from that marked in the drawings. For example, two blocks shown in succession may actually be executed substantially in parallel, or they may sometimes be executed in the reverse order, depending on the functions involved. It should also be noted that each block in the block diagram and/or the flowchart, and a combination of the blocks in the block diagram and/or the flowchart may be implemented by a dedicated hardware-based system that executes specified functions or operations, or may be implemented by a combination of dedicated hardware and computer instructions.

The involved units described in the embodiments of the present disclosure may be implemented by means of software, and may also be implemented by means of hardware. The name of a unit/module does not constitute a limitation on the unit itself under certain circumstances.

The functions described herein above may be at least partially performed by one or more hardware logic components. For example, without limitation, exemplary types of hardware logic components that may be used include: a field programmable gate array (FPGA), an application specific integrated circuit (ASIC), an application specific standard product (ASSP), a system on chip (SOC), a complex programmable logical device (CPLD) and the like.

In the context of the present disclosure, a machine-readable medium may be a tangible medium that may contain or store a program for use by or in combination with an instruction execution system, apparatus or device. The machine-readable medium may be a machine-readable signal medium or a machine-readable storage medium. The machine-readable medium may include, but is not limited to, an electronic, magnetic, optical, electromagnetic, infrared, or semiconductor system, apparatus or device, or any suitable combination of the above. More specific examples of the machine-readable storage medium may include an electrical connection based on one or more lines, a portable computer magnetic disk, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination of the above.

It should be noted that the embodiments in the specification are described in a progressive manner, and each embodiment focuses on the differences from other embodiments. The same or similar parts among the embodiments may be referred to each other. For the systems or apparatuses disclosed in the embodiments, since they correspond to the methods disclosed in the embodiments, the description is relatively simple, and reference may be made to the description of the method part for the related parts.

It should be understood that in the present application, “at least one (item)” refers to one or more, and “a plurality of” refers to two or more. “And/or” describes an association relationship between associated objects, and represents that three relationships may exist. For example, “A and/or B” may represent the following three cases: only A exists, only B exists, and both A and B exist, where A and B may be singular or plural. The character “/” generally indicates an “or” relationship between the associated objects before and after it. At least one of the following items (pieces)” or a similar expression thereof refers to any combination of these items, including a single item (piece) or any combination of a plurality of items (pieces). For example, at least one of a, b or c may represent: a, b, c, “a and b”, “a and c”, “b and c”, or “a, b and c”, where a, b and c may be single or multiple.

It should also be noted that in this paper, relational terms such as first and second are only used to distinguish one entity or operation from another entity or operation, and do not necessarily require or imply any actual relationship or order between these entities or operations. Moreover, terms “include”, “comprise” or any other variation thereof are intended to cover non-exclusive inclusion, so that a process, method, object or device including a series of elements includes not only those elements, but also other elements not explicitly listed or elements inherent to such process, method, object or device. Without further restrictions, an element defined by the phrase “including a” does not exclude that there are other same elements in the process, method, object or device including the element.

The steps of the method or algorithm described in conjunction with the embodiments disclosed herein may be directly implemented by hardware, a software module executed by a processor, or a combination thereof. The software module may be placed in a random access memory (RAM), a memory, a read-only memory (ROM), an electrically programmable ROM, an electrically erasable programmable ROM, a register, a hard disk, a removable magnetic disk, a CD-ROM, or any other form of storage medium known in the art.

It should be noted that the embodiments of the present application do not involve sensitive information of the user, and even if the related information of the user is used, the related information of the user is all acquired, used and determined after being authorized by the user.

The above description of the disclosed embodiments enables those skilled in the art to implement or use the present application. Various modifications to these embodiments will be apparent to those skilled in the art, and the general principles defined herein may be implemented in other embodiments without departing from the spirit or scope of the present application. Therefore, the present application will not be limited to the embodiments shown herein, but rather to the widest scope consistent with the principles and novel features disclosed herein.

1. A coding method, comprising:
acquiring, in response to a synthesis operation for multiple media files, a value of a file parameter of each of the multiple media files, wherein the synthesis operation is used for synthesizing the multiple media files into one media file;
determining a value of a coding parameter based on the value of the file parameter of each of the multiple media files, wherein the value of the coding parameter corresponds to a largest value among values of a corresponding file parameter of each of the multiple media files; and
coding the multiple media files according to the value of the coding parameter, to obtain a target media file, wherein the target media file is a result of performing the synthesis operation on the multiple media files.

2. The method of claim 1, wherein the multiple media files comprise a first file and a second file, the file parameter and the coding parameter each comprise a first parameter, a value of the first parameter of the first file is a first value, and a value of a first parameter of the second file is a second value; and determining the value of the coding parameter based on the value of the file parameter of each of the multiple media files comprises:
determining, in response to the first value being greater than or equal to the second value, a value of a first parameter in the coding parameter to be the first value.

3. The method of claim 1, wherein the multiple media files comprise a first file and a second file, the file parameter and the coding parameter each comprise a first parameter, a value of the first parameter of the first file is a first value, and a value of the first parameter of the second file is a second value; and determining the value of the coding parameter based on the value of the file parameter of each of the multiple media files comprises:
determining, in response to the first value being greater than the second value and the first value being greater than a target value, a value of a first parameter in the coding parameter to be the target value.

4. The method of claim 1, wherein the multiple media files comprise a first file and a second file, the file parameter and the coding parameter each comprise a first parameter, a value of the first parameter of the first file is a first value, and a value of a first parameter of the second file is a second value; and determining the value of the coding parameter based on the value of the file parameter of each of the multiple media files comprises:
determining, in response to the first value being greater than or equal to the second value, a value of a first parameter in the coding parameter to be a third value according to a preset mapping relationship, wherein the first value corresponds to the third value in the mapping relationship.

5. The method of claim 2, wherein before the synthesis operation is performed, the method further comprises:
in response to adding a third file to the synthesis operation, updating a value of the first parameter in the coding parameter to a fifth value corresponding to a fourth value if the fourth value is greater than the value of the first parameter in the coding parameter, wherein the fourth value is a value of the first parameter in the third file.

6. The method of claim 2, wherein before the synthesis operation is performed, the method further comprises:
in response to setting a value of the first parameter in the coding parameter to a sixth value, determining the value of the first parameter in the coding parameter to be the sixth value, regardless of a value of the first parameter of each of the multiple media files.

7. The method of claim 1, wherein a type of the media file comprises a video file, and the file parameter and the coding parameter each comprise at least one of the following parameters: bit rate, resolution and frame rate.

8. The method of claim 1, wherein a type of the media file comprises an audio file, and the file parameter and the coding parameter each comprise at least one of the following parameters: bit rate, sampling rate and bit depth.

9. The method of claim 1, wherein the synthesis operation for the multiple media files belongs to an export operation of a media editing task, and the multiple media files are comprised in the media editing task.

10. The method of claim 1, wherein before the multiple media files are coded according to the value of the coding parameter, the method further comprises:
displaying the value of the coding parameter; and
acquiring, in response to a confirmation operation or a modification operation of a user on the value of the coding parameter, a target value of the coding parameter; and
coding the multiple media files according to the value of the coding parameter comprises:
coding the multiple media files according to the target value of the coding parameter.

11. An electronic device, wherein the electronic device comprises: a processor and a memory;
the memory is configured to store an instruction or a computer program; and
the processor is configured to execute the instruction or the computer program in the memory, to cause the electronic device to perform a coding method comprising:
acquiring, in response to a synthesis operation for multiple media files, a value of a file parameter of each of the multiple media files, wherein the synthesis operation is used for synthesizing the multiple media files into one media file;
determining a value of a coding parameter based on the value of the file parameter of each of the multiple media files, wherein the value of the coding parameter corresponds to a largest value among values of a corresponding file parameter of each of the multiple media files; and
coding the multiple media files according to the value of the coding parameter, to obtain a target media file, wherein the target media file is a result of performing the synthesis operation on the multiple media files.

12. The electronic device of claim 11, wherein the multiple media files comprise a first file and a second file, the file parameter and the coding parameter each comprise a first parameter, a value of the first parameter of the first file is a first value, and a value of a first parameter of the second file is a second value; and determining the value of the coding parameter based on the value of the file parameter of each of the multiple media files comprises:
determining, in response to the first value being greater than or equal to the second value, a value of a first parameter in the coding parameter to be the first value.

13. The electronic device of claim 11, wherein the multiple media files comprise a first file and a second file, the file parameter and the coding parameter each comprise a first parameter, a value of the first parameter of the first file is a first value, and a value of the first parameter of the second file is a second value; and determining the value of the coding parameter based on the value of the file parameter of each of the multiple media files comprises:
determining, in response to the first value being greater than the second value and the first value being greater than a target value, a value of a first parameter in the coding parameter to be the target value.

14. The electronic device of claim 11, wherein the multiple media files comprise a first file and a second file, the file parameter and the coding parameter each comprise a first parameter, a value of the first parameter of the first file is a first value, and a value of a first parameter of the second file is a second value; and determining the value of the coding parameter based on the value of the file parameter of each of the multiple media files comprises:
determining, in response to the first value being greater than or equal to the second value, a value of a first parameter in the coding parameter to be a third value according to a preset mapping relationship, wherein the first value corresponds to the third value in the mapping relationship.

15. The electronic device of claim 12, wherein before the synthesis operation is performed, the method further comprises:
in response to adding a third file to the synthesis operation, updating a value of the first parameter in the coding parameter to a fifth value corresponding to a fourth value if the fourth value is greater than the value of the first parameter in the coding parameter, wherein the fourth value is a value of the first parameter in the third file.

16. A non-transitory computer-readable storage medium, wherein an instruction is stored in the computer-readable storage medium, and the instruction, when run on a processor, causes the processor to perform a coding method comprising:
acquiring, in response to a synthesis operation for multiple media files, a value of a file parameter of each of the multiple media files, wherein the synthesis operation is used for synthesizing the multiple media files into one media file;
determining a value of a coding parameter based on the value of the file parameter of each of the multiple media files, wherein the value of the coding parameter corresponds to a largest value among values of a corresponding file parameter of each of the multiple media files; and
coding the multiple media files according to the value of the coding parameter, to obtain a target media file, wherein the target media file is a result of performing the synthesis operation on the multiple media files.

17. The non-transitory computer-readable storage medium of claim 16, wherein the multiple media files comprise a first file and a second file, the file parameter and the coding parameter each comprise a first parameter, a value of the first parameter of the first file is a first value, and a value of a first parameter of the second file is a second value; and determining the value of the coding parameter based on the value of the file parameter of each of the multiple media files comprises:
determining, in response to the first value being greater than or equal to the second value, a value of a first parameter in the coding parameter to be the first value.

18. The non-transitory computer-readable storage medium of claim 16, wherein the multiple media files comprise a first file and a second file, the file parameter and the coding parameter each comprise a first parameter, a value of the first parameter of the first file is a first value, and a value of the first parameter of the second file is a second value; and determining the value of the coding parameter based on the value of the file parameter of each of the multiple media files comprises:
determining, in response to the first value being greater than the second value and the first value being greater than a target value, a value of a first parameter in the coding parameter to be the target value.

19. The non-transitory computer-readable storage medium of claim 16, wherein the multiple media files comprise a first file and a second file, the file parameter and the coding parameter each comprise a first parameter, a value of the first parameter of the first file is a first value, and a value of a first parameter of the second file is a second value; and determining the value of the coding parameter based on the value of the file parameter of each of the multiple media files comprises:
determining, in response to the first value being greater than or equal to the second value, a value of a first parameter in the coding parameter to be a third value according to a preset mapping relationship, wherein the first value corresponds to the third value in the mapping relationship.

20. The non-transitory computer-readable storage medium of claim 17, wherein before the synthesis operation is performed, the method further comprises:
in response to adding a third file to the synthesis operation, updating a value of the first parameter in the coding parameter to a fifth value corresponding to a fourth value if the fourth value is greater than the value of the first parameter in the coding parameter, wherein the fourth value is a value of the first parameter in the third file.
